(19) United States
(12) Patent Application Publication
(10) Pub. No.: US 2004/0214609 A1
(43) Pub. Date: Oct. 28, 2004

(54) Mobile station and method for managing multiple messaging contexts

(76) Inventors: Uday C. Sagi, Fort Worth, TX (US); Kevin Curtis Mowry, Irving, TX (US); Dwight Randall Smith, Grapevine, TX (US)

Correspondence Address: MOTOROLA INC, 600 NORTH US HIGHWAY 45, ROOM AS437, LIBERTYVILLE, IL, 60048-5343, US

(21) Appl. No.: 10/422,400

(22) Filed: Apr. 24, 2003

(51) Int. Cl. H04M 1/00

(52) U.S. Cl. 455/566; 455/517

(57) ABSTRACT

There is provided a mobile station communicating with one or more remote devices, and method thereof. The mobile station (102) comprises a display (220, 300) configured to identify two or more concurrent user contexts of the mobile station that communicate messages to the remote device or devices. The display (220, 500, 600) is also configured to provide a plurality of concurrent messaging sessions within a single window.

### FIELD OF THE INVENTION

The present invention relates generally to the field of systems, devices and methods for communicating messages between devices. In particular, the present invention relates to systems, portable devices and methods for wireless communication of visual or multimedia messages with other communication devices.

### BACKGROUND OF THE INVENTION

A messaging application of a personal computer typically establishes a new user context and opens a new window for each messaging session that is initiated at the personal computer. When a user has multiple accounts or multiple users utilize the same personal computer simultaneously, each new context of a messaging application is initiated and each such application has a separate TCP connection to a messaging server. For example, if four users are using a messaging service from the same personal computer (i.e., connected at the same time) and each user has four messaging sessions established with four contacts, then sixteen session windows will be open on the personal computer, not to mention any additional windows that may be opened by the messaging application.

It is particularly difficult to have multiple contexts utilizing simultaneously one or more messaging applications of a wireless communication device. In such cases, it is difficult to manage a large quantity of windows on a screen that is limited in size. Accordingly, there is a need for a portable device, and a method thereof, that permit multiple contexts to efficiently establish and share messaging services on the device. In addition, there is need for a portable device, and a method thereof, that permit multiple sessions to efficiently operate messaging services on a limited-sized screen of the device.

### BRIEF DESCRIPTION OF THE DRAWINGS

FIG. 1 is a block diagram representing a communication system in accordance with the present invention.

FIG. 2 is a block diagram representing one or more devices of FIG. 1.

FIG. 3 is a screen view representing an exemplary status window that may be displayed by one or more devices of FIG. 1.

FIG. 4 is a screen view representing an exemplary login window that may be displayed by one or more devices of FIG. 1.

FIG. 5 is a screen view representing an exemplary mailbox window that may be displayed by one or more devices of FIG. 1.

FIG. 6 is a screen view representing another exemplary mailbox window that may be displayed by one or more devices of FIG. 1.

FIG. 7 is a flow diagram representing a preferred operation of one or more devices of FIG. 1.

FIG. 8 is a flow diagram representing a preferred mailbox procedure called by the preferred operation of FIG. 7.

FIG. 9 is a flow diagram representing a preferred message sending procedure called by the preferred operation of FIG. 7.

FIG. 10 is a flow diagram representing a preferred message receiving procedure called by the preferred operation of FIG. 7.

### DETAILED DESCRIPTION OF THE PREFERRED EMBODIMENTS

A mobile station and method that permits multiple user contexts to establish messaging services on the mobile station is provided. These user contexts being formed by one or more users having one or more sessions connecting with messaging services. Also, a mobile station and method that permit multiple sessions to efficiently operate messaging services on a limited-sized screen of the mobile station is provided.

It is an aspect of the present invention that a mobile station communicates with one or more remote devices, and method thereof. The mobile station comprises a display configured to identify two or more concurrent context or users of the mobile station that communicate messages to the remote device or devices. The display is also configured to provide a plurality of concurrent messaging sessions within a single window.

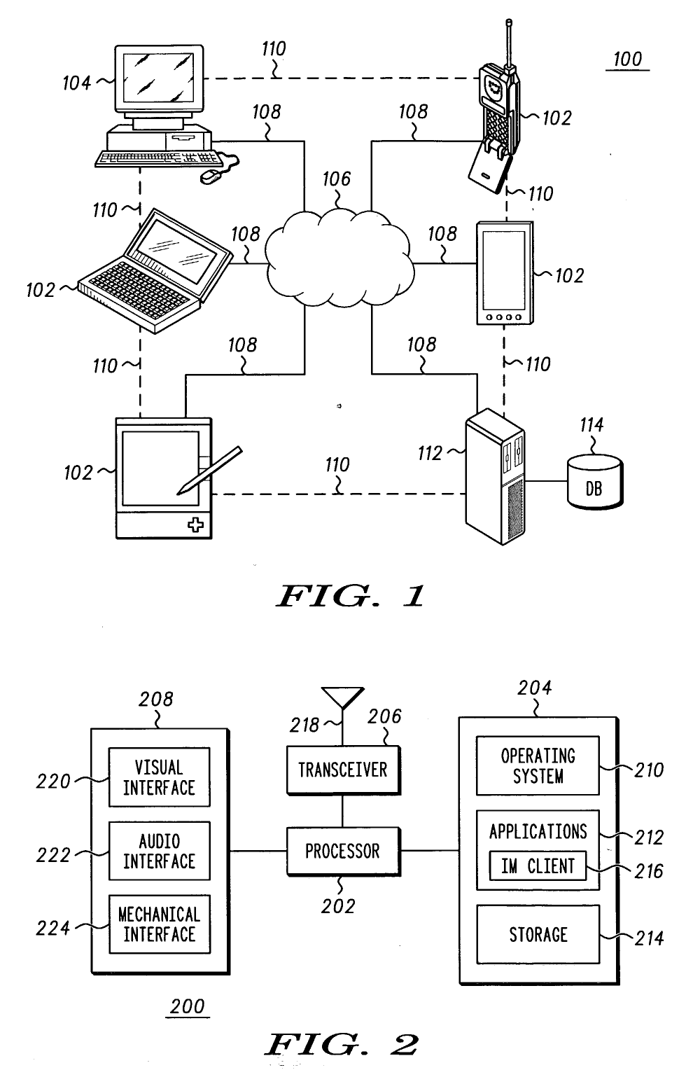

Referring to FIG. 1, there is shown a communication system 100 in accordance with the present invention. The communication system 100 includes a plurality of communication devices 102, 104 communicating with each other. For one embodiment of the system 100, the plurality of communication devices 102, 104 may communicate through a communications network 106 via network connections 108 as shown in FIG. 1. For another embodiment of the system 100, the plurality of communication devices 102, 104 may communicate with each other directly via direct links 110, i.e., a point-to-point or ad hoc network.

The communication system 100 is described in terms of several preferred embodiments, and particularly, in terms of a wireless communication system operating in accordance with at least one of several standards. These standards include analog, digital or dual-mode communication system protocols that utilize one or more communications networks 106 and network connections 108 such as, but not limited to, the Advanced Mobile Phone System (“AMPS”), the Narrowband Advanced Mobile Phone System (“NAMPS”), the Global System for Mobile Communications (“GSM”), the IS-55 Time Division Multiple Access (“TDMA”) digital cellular system, the IS-95 Code Division Multiple Access (“CDMA”) digital cellular system, CDMA 2000, the Personal Communications System (“PCS”), 3G, the Universal Mobile Telecommunications System (“UMTS”), and variations and evolutions of these protocols. As stated above, the communication system 100 may also operate by ad hoc network via direct links 110 and, thus, provide point-to-point communication with the need for intervening infrastructure. Examples of the communication protocols used by the ad hoc networks include, but are not limited to, IEEE 802.11a, IEEE 802.11b, IEEE 802.11g, Bluetooth, and infrared technologies.

The communication system 100 may employ any communication device, including mobile stations 102 having limited-sized displays. Examples of mobile stations 102 that have limited-sized displays include, but are not limited to, personal digital assistants (“PDA's”), cellular telephones, radiophones, handheld computers, small portable/laptop/notebook/sub-notebook computers, tablet computers, hybrid mobile stations, and the like.

It is to be understood that, although multiple mobile stations 102 may communication with each other, the present invention only requires one mobile station to be communicating within the communication system 100. Accordingly, one or more mobile station 102 may communication with one or more non-mobile stations 104 as well as other mobile stations.

The communication system 100 also includes a messaging application for operating a messaging system among the communication devices 102, 104. For one embodiment, the messaging application may be operated by a server 112 and associated database 114 that communicate through the communication network 106 via the network connections 108, communicate with the communication devices 102, 104 directly via direct links 110, or a combination thereof. For another embodiment, the messaging application may be operated by one of the communication devices 102, 104 communicating with other communication devices, or distributed among a plurality of communication devices, that communicate through the communication networks 106 via the network connections 108, communicate directly via direct links 110, or a combination thereof.

FIG. 2 shows various exemplary components that may be utilized by each communication device 102, 104 of the communication system 100. Each communication device 102, 104 may include a processor 202 and a memory 204, a transceiver 206, and a user interface 208 that are coupled together for operation of the respective communication device. It is to be understood that two or more of these internal components 200 may be integrated within a single package, or functions of each internal component may be distributed among multiple packages, without adversely affecting the operation of each mobile station 102, 104.

As stated above, each communication device 102, 104 includes the processor 202 and the memory 204. The processor 202 controls the general operation of the communication device 102, 104 including, but not limited to, processing and generating data for each of the other internal components 200. The memory 204 may include an operating system 210, an application portion 212, and/or a data portion 214. The operating system 210 is utilized by the processor 202 for instructions for general operations of the communication device 102, 104. The application portion 212 includes operating instructions for the processor 202 to perform various functions of the communication device 102, 104. A program of the set of the operating instructions may be embodied in a computer-readable medium such as, but not limited to, paper, a programmable gate array, flash memory, application specific integrated circuit (“ASIC”), erasable programmable read only memory (“EPROM”), read only memory (“ROM”), random access memory (“RAM”), magnetic media, and optical media. The data portion 214 stores data that is utilized by the applications stored in the application portion 212. For the preferred embodiment, the applications portion 212 is non-volatile memory that includes a client application 216 for communicating with a main application operated at a remote device, and the data portion 214 is also non-volatile memory that stores data in a database that is utilized by the client application and associated with the communication device 102, 104 or user of the communication device. In the alternative, a messaging system, or a portion thereof, may be stored in the memory 204 of a particular communication device 102, 104.

Each communication device 102, 104 also includes the transceiver 206 and the user interface 208. The transceiver 206 provides communication capabilities with other entities, such as the communication network 108 and/or other communication devices 102, 104. For the preferred embodiment, the transceiver 206 operates through an antenna 218 in accordance with at least one of several standards including analog, digital or dual-mode communication system protocols and, thus, communicates with appropriate infrastructure. However, as referenced above, the transceiver 206 may also provided point-to-point communication via an ad hoc network. The user interface 208 may include a visual interface 220, an audio interface 222 and/or a mechanical interface 224. Examples of the visual interface 220 include displays and cameras, examples of the audio interface 222 include speakers and microphones, and examples of the mechanical interface 224 includes keypads, touch pads, selection buttons, vibrating mechanisms, and contact sensors. For example, a user may utilized the user interface 208 to provide input to a display and make selections for the display by using mechanical instructions, e.g., touching a touch pad overlapping the display, keypad keys or selection buttons, or providing audible commands and data into a microphone. For all preferred embodiments of the present invention, each communication device 102, 104 includes a display to provide output information associated with the messaging system to corresponding users. On the other hand, alternative embodiments may include other types of output devices, audio or mechanical, to provide output to users.

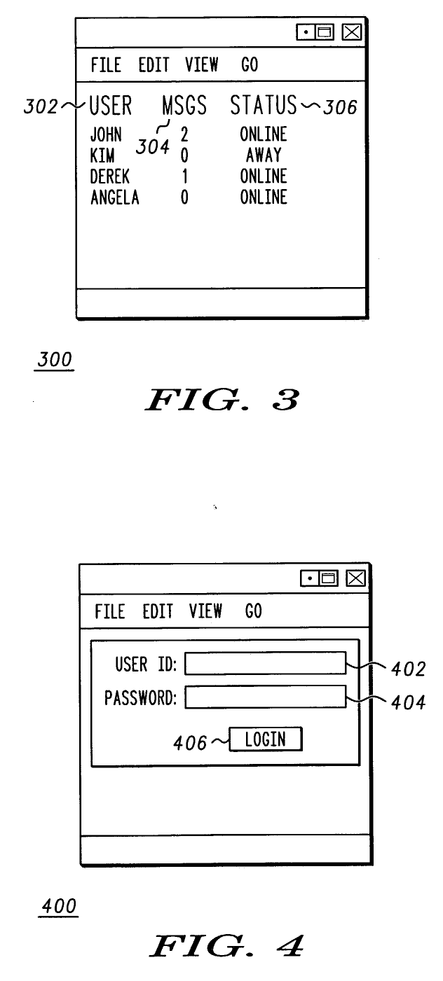

Referring to FIG. 3, there is provided a screen view representing an exemplary status window that may be displayed by one or more communication devices, but is particularly applicable to the mobile stations 102 having limited-sized displays. The visual interface 220 of the mobile station 102 may provide a status window 300 that includes a list of user names corresponding to concurrent user contexts of the mobile station that communicate messages to one or more remote devices. The list may also include other user names corresponding to inactive or off-line user contexts of the mobile station 102 and/or other users currently logged into the messaging system that are remote from the mobile station. For example, each user context may display the username as associated with the commercial or corporate message service (e.g., name@messageservice.com, firstname.lastname@messageservice.com, and the like). For the preferred embodiment, as shown in FIG. 3, the status window 300 includes a list of user names 302 as well as corresponding quantity of messages 304 and status information 306. For the example shown, John, Derek and Angela are identified as concurrent users of the mobile station 102 that communicate messages to one or more remote devices. John has two messages in his mailbox, Derek has one message in his mailbox, and Angela does not have any messages in her mailbox. Kim is identified as an “away” user and does not have any messages in her mailbox.

The mobile station 102 may notify an appropriate user or users when a new message is received. The notification may be delivered by the visual interface 220, the audio interface 222, and/or the mechanical interface 224. For the preferred embodiment, when a new message is received for a particular user by the mobile station 102, the user interface 208 of the mobile station highlights the user name 302 corresponding to the particular user in the status window 300 and emits an audio tone. Preferably, a different visual, audio and/or mechanical notification is provided for each user or user context.

When a particular user name 302 is selected using the user interface 208, the mailbox window corresponding to the particular user name may be brought to the forefront of the display, i.e., the visual interface 220. At such time, the user may read, reply or forward any incoming messages, maintain the mailbox window or close the mailbox window. After a predetermined period of inactivity, the status window 300 may be brought to the forefront of the display. The predetermined period may be pre-configured for the mobile station 102 or user configured by a user of the mobile station.

For security purposes, the status window 300, as well as any other window of the client application 216 or messaging system, may require a passcode before the window may be displayed in order to prevent unauthorized users from viewing the contents. Also, the status information 306 of the status window 300 may be modified by a user of the mobile station 102, and such modification may also require a passcode in order to take effect. The passcode may be associated to a user which would permit access to any of their contexts, or could be required for each user context as required for implementation or user needs.

The status window 300 may display user names 302 and corresponding user information 304, 306 in an ordered fashion, particularly if there are more user names than lines on the display to accommodate the user names. Preferably, the mobile station 102 would order the user names based on a scheme that facilitates identification of a user or users who need access to the mobile station. For example, the status window 300 may display user names 302 in order of most-recently active users or in order of most-recently unacknowledged messages.

Referring to FIG. 4, there is provided a screen view representing an exemplary login window that may be displayed by one or more communication devices, but is particularly applicable to the mobile stations 102 having limited-sized displays. The visual interface 220 of the mobile station 102 may provide a login window 400 that provides a user with access to the messaging system if the proper login information is provided by a user. As shown in FIG. 4, the login window 400 includes a user ID area 402 for entering a user identification, a password area 404 for entering a user password or passcode, and a login button 406 for submitting the entered user ID and password to the client application 216 or messaging system to request access. After the user is successfully logged in, a new mailbox window (as described below) is created for the user and the status window 300 is updated.

For the preferred embodiments, several processes occur when a user logs in successfully. In support of the login process, the connection to the messaging system initiates downloading of a contact list to the mobile station 102 and initial updates to the status of the contacts identified by the contact list. The contacts of the contact list may identify individual people or a group of people. For one preferred embodiment, the mobile station 102 would identify contacts that are concurrent users of the mobile station and flag them since the logical identities of all connected user would be known. Thus, it may restrict a loopback scenario while utilizing these contacts when one user would send a message to another user on the same device, i.e., the mobile station 102.

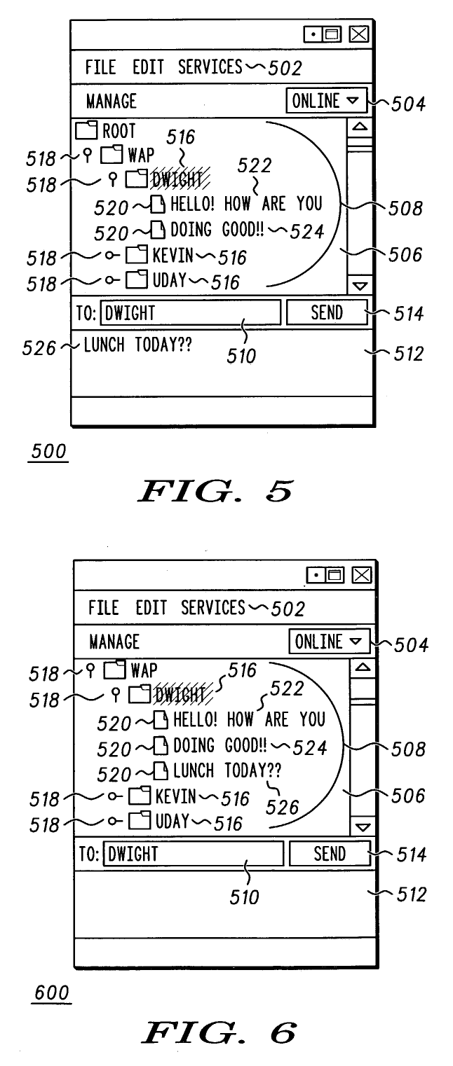

Referring to FIGS. 5 and 6, there are provided screen views representing exemplary mailbox windows 500, 600 that may be displayed by one or more communication devices, but is particularly applicable to the mobile stations 102 having limited-sized displays. Preferably, each user would have his or her personal mailbox window 500, 600 but, in the alternative, two or more users may share the same mailbox window. Each mailbox window 500, 600 may include one or more features to facilitate viewing of output or entering of input. For example, as shown in FIGS. 5 and 6, each mailbox window 500, 600 may include a pull down menu 502, a drop down list 504, an output area 506 including a collapsible tree 508, a recipient identifier area 510, an input area 512, and a transaction button 514. The pull down menu 502 may be used to manage contacts who are communicating with the current user. For example, the pull down menu 502 in FIGS. 5 and 6 referenced by the word “Services” may include selections to add, edit and/or remove contacts. The drop down list 504 may be used to select a current user's presence and/or status information. Examples of such information include, but are not limited to, the current user being online, away, and the like.

The output area 506 may be used to display the collapsible tree 508 to the current user, and the collapsible tree includes one or more contacts of the current user along with each contact's presence information. Each contact of the collapsible tree 508 is a separate node 516 that is alternately expandable and collapsible. When a particular node 516 is expanded by selecting the particular node, one or more messages corresponding to the particular node (e.g., corresponding to an individual person or a group of people) are displayed adjacent to the node in the output area 506. All messages corresponding to the node 516 may be displayed in the output area 506, or a partial list of messages corresponding to the node may be displayed in the output area. The partial list may include a select group of messages based on date/time of receipt, message type, message size, attachments, header information, a maximum message quantity set in advance, and the like. For the preferred embodiments, the most recent messages are shown in the output area 506 just below the corresponding node 516 and, preferring, all messages received since the login time of the user as shown. When an expanded node 516 is selected, then the node is collapsed so that none of the messages corresponding to the node are displayed.

The output area 506 may also include node icons 518 and/or message icons 520. The node icons 518 may indicate whether each node of the collapsible tree is expanded or collapsed. Each node icon 518 is particularly useful in quickly identifying a node 516 that does not have any corresponding messages. The message icons 520 may indicate the type of messages that is displayed in the output area 506. For example, the message icons may differentiate received messages from sent messages, recent messages from older messages, stationary device messages from mobile station messages, messages sent to a group from messages sent to an individual, messages from different individuals within a node corresponding to a group of people, and the like.

As stated above, each mailbox window 500, 600 may include a recipient identifier area 510, an input area 512, and a transaction button 514. The recipient identifier area 510 indicates the currently selected recipient of the current user's next message. For the preferred embodiments, the current user may select a node 516 in the output area 506 to select a potential recipient, but the current user may also provide the potential recipient name and/or address in the recipient identifier area 510. The input area 512 displays the next message to be sent by the current user. Preferably, the input area 512 is clear immediately after each message is sent. The transaction button 514 provides one or more functions for managing each message sent or to be sent by the current user. Examples of transaction buttons 514 include, but are not limited to, a “Send” button to initiate transfer of a message in the input are 512 when the button is selected by the current user and a “Forward” button to attach an item, icon and/or file to the next message.

The following example demonstrates a possible scenario for using the mailbox windows 500, 600 shown in FIGS. 5 and 6. In FIG. 5, there is shown a “dwight” node 516 that corresponds to a messaging session between the current user and a user named Dwight. Before the messaging session began, the current user selected the “dwight” node of the collapsible tree 508 and so the node was highlighted in the output area 506 and “dwight” was indicated in the recipient identifier area 510. For this example, the current user has already sent a first message 522 to Dwight stating “Hello! How are you”, and Dwight has already returned a second message 524 to the current user stating “Doing good!!”. Also, the current user is in the process of preparing to send another message to Dwight and has provided a third message 526 stating “Lunch today??” in the input area 512. Since the current user continues to communicate with Dwight, Dwight's name continues to be displayed in the recipient identifier area 510. FIG. 6 represents the mailbox window 600 after the current user selects the transaction button 514 in the condition represented by FIG. 5. In particular, the input area becomes clear or blank, and the third message is moved to the output area 506 to become the most recent message corresponding to the “dwight” node 516.

The data in the recipient identifier area 510 may change in one or more of the following ways. As stated above, the data in the recipient identifier area 510 may change when the current user selects a node 516 in the output area 506 if the node corresponds to a different contact. Optionally, the data in the recipient identifier area 510 may change if the current user provides new data directly in the recipient identifier area, as opposed to indirectly via the output area 506. As another option, the data in the recipient identifier area 510 may change if a new message corresponding to a different node 516 is received by the mobile station 102. For this last case, the recipient identifier area 510 will identify the node 516 that corresponds to the more recently received message.

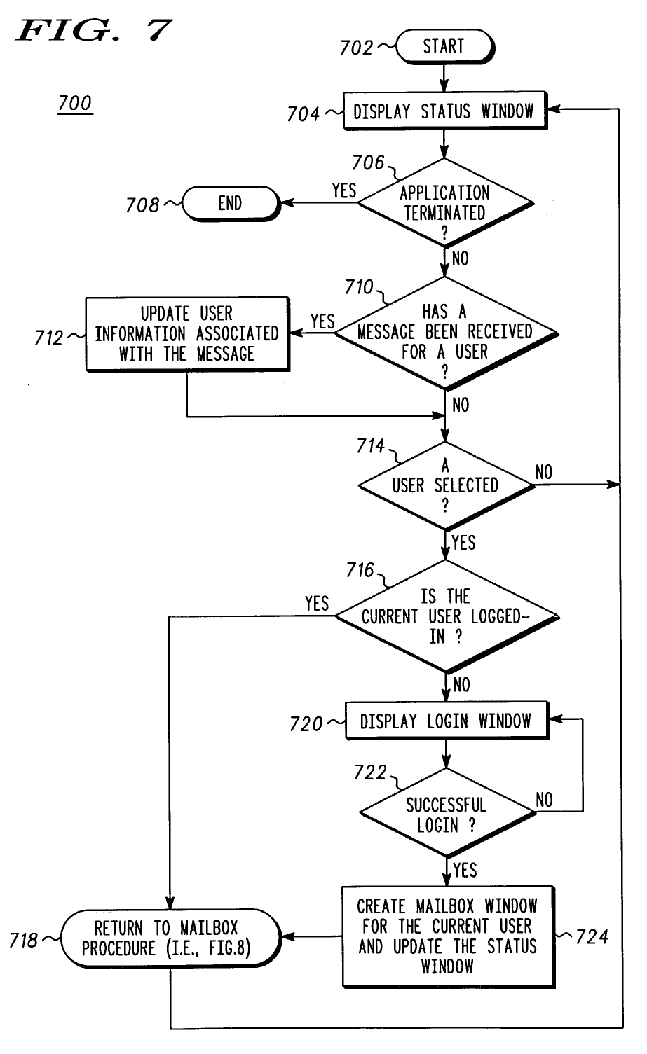

Referring to FIG. 7, there is provided a flow diagram representing a preferred operation 700 of one or more communication devices, but is particularly applicable to the mobile stations 102 having limited-sized displays. The preferred operation 700 is preferably executed by an application 212, such as the client application 216, and is initiated at step 702. After the preferred operation 700 is initiated, a status window 300 is provided by the visual interface 220 of the user interface 208 at step 704. Next, the processor 202 determines whether the application 212 has received an instruction, from the current user or another entity, to terminate at step 706. If the processor 202 has received an instruction to terminate, then the preferred operation 700 is terminated at step 708. Otherwise, continues to step 710.

The preferred operation 700 then determines whether a new message have been received for a particular user of the mobile station 102 at step 710. The particular user must be identified by the list of user names corresponding to concurrent users of the mobile station 102 as described above in reference to FIG. 3. If a new message has been received, then user information associated with the new message is updated at step 712. For example, if the new message is directed to a concurrent user of the mobile station 102, then the quantity of messages 304 for that particular user will be incremented by one message. Optionally, the particular user name 302 and/or corresponding user information 304, 306 may be highlighted in the status window 300.

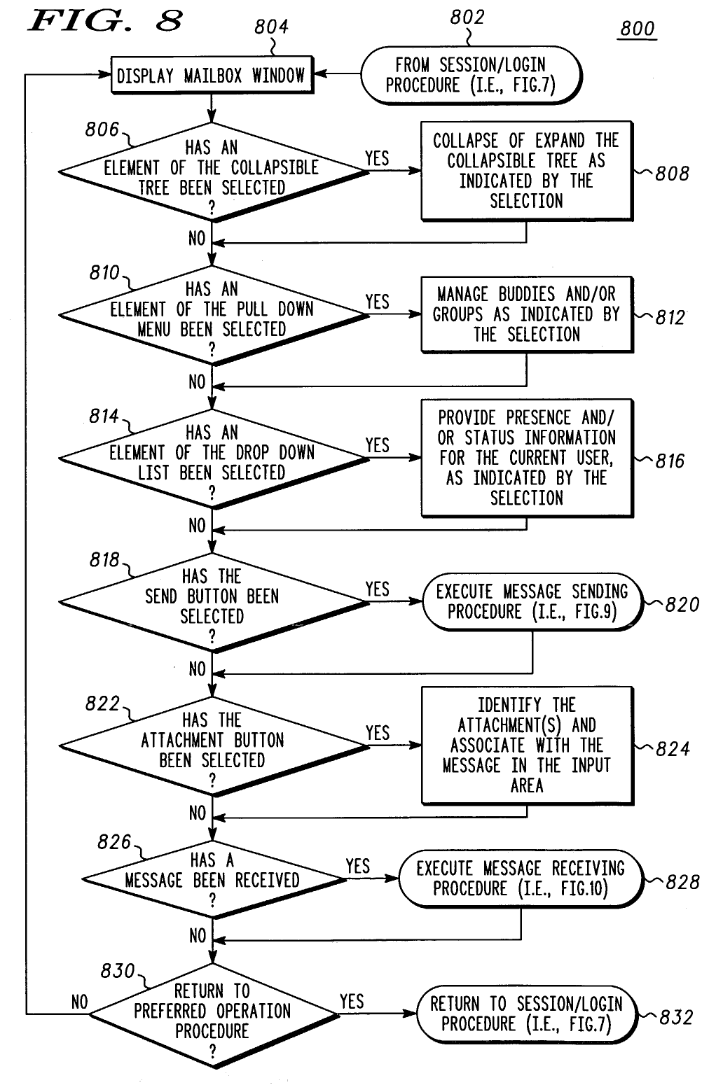

After determining whether a new message has been received, regardless of whether one has been received or not, the user interface 208 determines whether a user name 302 has been selected by the current user of the mobile station 102. If not, then the preferred operation 700 returns to step 704 where it updates the status window 300 if any information of the status has been changed. If a user name 302 has been selected, then the processor determines whether the current user is logged-in to the messaging system at step 716. If so, then the processor executes a mailbox window procedure, described below and shown in FIG. 8, at step 718. If the current user is not logged-in to the messaging system, then the user interface 208 displays a login window 400 at step 720 so that the current user may login to the messages system. As represented by step 722, the user interface 208 will continue to display the login window 400 until the current user logs in successfully. Of course, in the alternative, the preferred operation 700 may also lock-out the current user from the login window 400 if the current user has more than a predetermined number of unsuccessful attempts at logging in to the messaging system. After the current user logs in to the messaging system successfully, the processor 202 creates a mailbox window 500, 600 for the current user and updates the status window 300 at step 724. Also, the preferred operation 700 executes the mailbox window procedure at step 718. After the mailbox window procedure is executed at step 718, regardless of whether the current user is already logged-in or has just completed a successful login, the preferred operation 700 returns to displaying the status window 704 via the user interface 208 at step 704.

Referring to FIG. 8, there is provided a flow diagram representing a preferred mailbox procedure 800 called by the preferred operation 700. Beginning at step 802, the preferred mailbox procedure 800 displays the mailbox window 500, 600 corresponding to the current user via the user interface 208 at step 804. Thereafter, the preferred mailbox procedure 800 may perform a variety of functions based on the capabilities of the mobile station 102 as well as whether the current user has activated one or more of these functions. Although these functions are presented in a particular order in FIG. 8, it is to be understood that the preferred mailbox procedure 800 may review these functions in any order so long as all relevant functions are reviewed in a timely fashion.

Based on input received by the user interface 208, the processor 202 may determine whether an element or node 516 of the collapsible tree 508 has been selected at step 806. If so, then the collapsible tree 508 is shown in the user interface 208 to be expanded or collapsed based on the current state of the element or node 516 at step 808. In particular, the element or node 516 is collapsed if it is presently expanded and the element or node is expanded if it is presently collapsed.

Based on input received by the user interface 208, the processor 202 may determine whether an element of the pull down menu 502 has been selected at step 810. If so, then the pull down menu 502 is shown in the user interface 208 to include various sub-functions that manage contacts at step 812. For example, contacts may be added, edited, or removed if such sub-function is selected by the current user.

Based on input received by the user interface 208, the processor 202 may determine whether an element of the drop down list 504 has been selected at step 814. If so, then the drop down list 504 is shown in the user interface 208 to include various sub-functions to manage user information at step 816. For example, the presence and/or status information of the current user may be changed if such sub-function is selected by the current user.

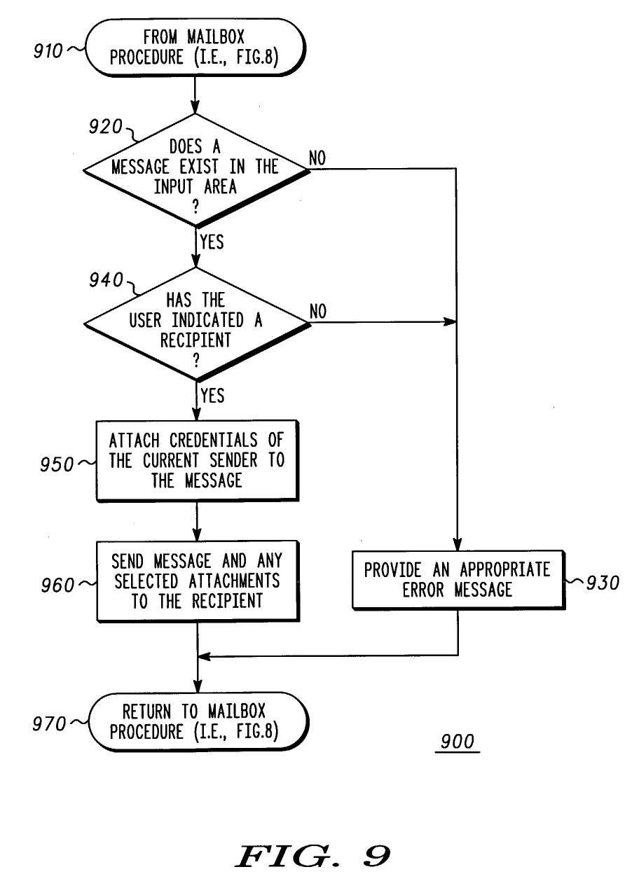

Based on input received by the user interface 208, the processor 202 may determine whether the transaction button 514 has been selected. If the transaction button 514 is selected by the current user and the button corresponds to a “send” function (as represented by step 818), then the mailbox procedure 800 executes a message sending procedure at step 820, as described below and shown in FIG. 9. If the transaction button 514 is selected by the current user and the button corresponds to an “attachment” function (as represented by step 822), then the processor 202 identifies one or more attachments and associates them with the message shown in the input area 512 at step 824. The processor 202 may identify the attachment or attachments based on user input received from the current user via the user interface 208, such as selection of a file located in the data portion 214 of the memory 204 or selection of a link identified by a browser of the applications portion 212.

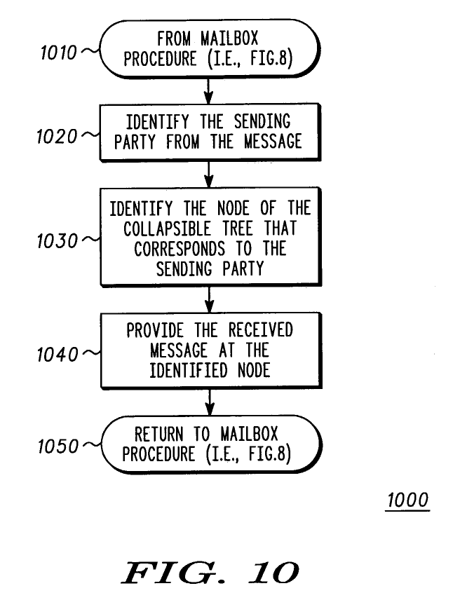

Based on input received by the transceiver 206, the processor 202 may determine whether a new message has been received at step 826. If so, then the mailbox procedure 800 executes a message receiving procedure at step 828, as described below and shown in FIG. 10.

After reviewing one or more of the above functions, the mailbox procedure 800 determines whether to return to the preferred operation 700 at step 830. For the preferred embodiments, the processor 202 returns to the preferred operation 700 when the current user indicates a desire to do so via the user interface 208. If the mailbox procedure 800 determines that it will return to the preferred operation 700, then the mailbox procedure does so at step 832. Otherwise, the mailbox procedure 800 returns to step 804 where it updates the mailbox window 500, 600 if any information of the mailbox window has been changed and review one or more appropriate or desired functions.

Referring to FIG. 9, there is provided a flow diagram representing a preferred message sending procedure 900 called by the preferred operation 700. As described above, the message sending procedure 900 is executed if the current user selects the transaction button 514 of the mailbox window 500, 600. Beginning at step 910, the message sending procedure 900 determines whether a message exists in the input area 512 of the mailbox window 500, 600 at step 920. If the input area 512 does not include any type of message or attachment, then the transceiver 206 does not have any message to send to a recipient. Therefore, the processor 202 provides an appropriate error message via the user interface 208 to the current user at step 930. In the alternative, if the messaging system permits one device to send a blank message to another device, then step 920 may be eliminated from the message sending procedure 900.

If the input area includes a message and/or an attachment, the message sending procedure determines whether the current user has indicated a recipient or a recipient's address in the recipient identifier area 510 at step 940. If not, then the processor 202 provides an appropriate error message via the user interface 208 to the current user at step 930. If the current user has indicated a recipient or a recipient's address in the recipient identifier area 510, then the processor 202 attaches credential of the current user to the message to be sent at step 950. Since more than one user may user the mobile station 202 concurrently, the processor 202 attaches credentials to every outgoing message in the form of headers, such as cookies for a hypertext transfer protocol (“HTTP”), or as part of an extensible markup language (“XML”) message. The message and any selected attachment(s) are then sent by the transceiver 206 to the identified recipient at step 960. After a message is sent at step 960 or after an error message is provided to the current user at step 930, operation returns to the mailbox procedure 800 at step 970.

Referring to FIG. 10, there is provided a flow diagram representing a preferred message receiving procedure called by the preferred operation 700. As described above, the message receiving procedure 1000 is executed if transceiver 206 detects that a new message has been received at step 826. Since more than one user may use the mobile station 202 concurrently, the processor 202 must route each incoming message to the mailbox of the appropriate user. In addition, the processor 202 must route each incoming message to the appropriate node of the appropriate user. Thus, beginning at step 1010, the processor 202 identifies the sending party based on the information contained within an incoming message, such as its header, at step 1020. The processor 202 then identifies the node 516 of the collapsible tree 508 that corresponds to the sending party. Thereafter, the received message is provided adjacent to the identified node 516 of the mailbox window 500, 600.

When the messaging application is operated by a server 112 and associated database 114, the client application on the communication device 102 may utilize a single communication channel with the server 112 rather than requiring separate communication channels for each user context utilizing the device. This would help maintain the logical associations when the communication device 102 goes in and out of coverage, when broadcast messages are sent to the communication device 102, and a single communication channel reduces the traffic associated with overhead communication incurred when establishing connections.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A mobile station communicating with at least one remote device comprising:
a display configured to identify at least two concurrent contexts of the mobile station that communicate messages to the at least one remote device.

2. The mobile station of claim 1, wherein the at least two concurrent contexts are active for a single user of the mobile station.

3. The mobile station of claim 1, wherein the at least two concurrent contexts are active for at least two concurrent users of the mobile station.

4. The mobile station of claim 1, further comprising a circuit, coupled to the display, configured to employ a single connection to send and receive the messages.

5. The mobile station of claim 1, further comprising a circuit, coupled to the display, configured to maintain a single connection with a server over a wireless communication system to enable delivery of the messages.

6. A mobile station communicating with at least one remote device comprising:
a display configured to identify at least two concurrent users of the mobile station that communicate messages to the at least one remote device.

7. The mobile station of claim 6, wherein:
each user of the at least two concurrent users has at least one active session managed by the mobile station, and all sessions of the at least one active session operate concurrently; and
only one user may operate the mobile station at any given time.

8. The mobile station of claim 6, wherein the display provides a list of users and a status corresponding to each user of the list.

9. The mobile station of claim 6, further comprising a user interface configured to notify the concurrent users of incoming messages, wherein a different notification is provided for each concurrent user.

10. The mobile station of claim 6, further comprising a transceiver configured to communicate the messages via a wireless communication system.

11. The mobile station of claim 6, further comprising a transceiver configured to employ a single connection to send and receive the messages.

12. The mobile station of claim 6, a transceiver configured to maintain a single connection with a server over a wireless communication system to enable delivery of the messages.

13. The mobile station of claim 6, further comprising a processor configured to route incoming messages to appropriate users based on recipient information and to include appropriate sender information with outgoing messages.

14. A mobile station communicating with at least one remote device comprising:
a display configured to provide a plurality of concurrent messaging sessions within a single window.

15. The mobile station of claim 14, wherein:
the display provides the plurality of concurrent sessions in a tree format; and
messages are categorized by their association to the concurrent sessions.

16. The mobile station of claim 15, wherein the tree format includes a plurality of nodes, each node corresponding to a different session.

17. The mobile station of claim 16, wherein each message is provided in the tree format at the node associated with the appropriate session.

18. The mobile station of claim 16, further comprising a processor configured to route incoming messages to appropriate nodes and to include appropriate user information to outgoing messages.

19. The mobile station of claim 14, further comprising a transceiver configured to communicate the messages via a wireless communication system.

20. The mobile station of claim 14, further comprising a transceiver configured to employ a single connection to send and receive messages.

21. The mobile station of claim 14, a transceiver configured to maintain a single connection with a server over a wireless communication system to enable delivery of messages.

22. A method of a mobile station for managing a plurality of messaging users, the method comprising:
displaying concurrent contexts of the mobile station that communicate messages to the at least one remote device.

23. The method of claim 22, wherein displaying concurrent contexts of the mobile station includes permitting control of the concurrent contexts by a single user of the mobile station.

24. The method of claim 22, wherein displaying concurrent contexts of the mobile station includes permitting control of the concurrent context by at least two concurrent users of the mobile station.

25. The method of claim 22, further comprising employing a single connection to send and receive the messages.

26. The method of claim 22, further comprising maintaining a single connection with a server over a wireless communication system to enable delivery of the messages.

27. A method of a mobile station for managing a plurality of messaging users, the method comprising:
displaying concurrent users of the mobile station that communicate messages to the at least one remote device.

28. The method of claim 27, wherein displaying concurrent users of the mobile stations includes providing a list of users and a status corresponding to each user of the list.

29. The method of claim 27, further comprising notifying users of incoming messages, wherein a different notification is provided for each concurrent user.

30. The method of claim 27, further comprising communicating the messages via a wireless communication system.

31. The method of claim 27, further comprising:
routing incoming messages to appropriate users; and
including appropriate sender information with outgoing messages.

32. The method of claim 27, further comprising employing a single connection to send and receive the messages.

33. The method of claim 27, further comprising maintaining a single connection with a server over a wireless communication system to enable delivery of the messages.

34. A method of a mobile station for managing a plurality of messaging users, the method comprising:
displaying concurrent messaging sessions within a mailbox window.

35. The method of claim 34, wherein displaying concurrent messaging sessions within a mailbox window includes displaying the concurrent messaging sessions in a tree format within the mailbox window.

36. The method of claim 35, further comprising:
identifying a node of the tree format that corresponds to a sender of an incoming message; and
providing the received message at the node.

37. The method of claim 34, further comprising communicating messages via a wireless communication system.

38. The method of claim 34, further comprising:
attaching credentials of a sender to an outgoing message; and
sending the message to a recipient of the outgoing message.

39. The method of claim 34, further comprising employing a single connection to send and receive messages.

40. The method of claim 34, further comprising maintaining a single connection with a server over a wireless communication system to enable delivery of messages.
